(19) United States
(12) Patent Application Publication
(10) Pub. No.: US 2016/0281827 A1
(43) Pub. Date: Sep. 29, 2016

(54) A Mechanical Transmission For a Mail Stacker Unit With a Clutch Brake and Elliptical Gearing

(71) Applicant: SOLYSTIC, Bagneux (FR)

(72) Inventor: Wilfrid BEAUGRAND, Valence (FR)

(73) Assignee: SOLYSTIC, Bagneux (FR)

(21) Appl. No.: 14/889,357

(22) PCT Filed: Aug. 20, 2015
(86) PCT No.: PCT/FR2015/052232

§ 371 Date: Nov. 5, 2015

(30) Foreign Application Priority Data
Sep. 9, 2014 (FR) 1458424

(51) Int. Cl. F16H 35/02; B65H 31/06; B65H 29/60; B07C 3/00; B65H 29/40

(52) U.S. Cl. CPC F16H 35/02; B07C 3/008; B65H 29/40; B65H 29/60; B65H 31/06; F16H 2035/001

(57) ABSTRACT

A mail stacker unit in a postal sorting machine includes a stacking actuator (22) driven in stop-start rotation for the purpose of stacking mailpieces on edge in a storage receptacle. The actuator is coupled in rotation to a clutch brake (34) driven at constant speed, and elliptical gearing (30, 31) is also provided between the clutch brake and said stacking actuator.

### TECHNICAL FIELD

The invention relates to a stacker unit including a stacking actuator driven in stop-start rotation for the purpose of stacking flat articles on edge in a storage receptacle.

The invention applies more particularly to stacking flat mailpieces but it is also applicable to stacking other flat articles such as banknotes, for example.

A postal sorting machine may have a large number of sorting outlets. For example, in postal sorting machines for small envelopes, each sorting outlet can be constituted by a stacker as indicated above.

The storage receptacle of the stacker can contain a large number of envelopes, and up to about twenty kilograms of mail in a stack and on edge. Such a stacker is suitable for stacking, at the head of the stack, a new mailpiece that is brought by an on-edge conveyor to the sorting outlet in question. Generally, the on-edge conveyor is a conveyor having nipping belts.

### PRIOR ART

Such a stacker for a postal sorting machine is, for example, described in Patent WO 2013/093251 or in patent WO 2013/093250.

In such a known stacker, the electromechanical stacking actuator is a sort of bucket wheel that turns in stop-start manner so that it turns through one half of a turn every time it starts.

Every time the bucket wheel turns through one half-turn, a “bucket” comes to take a new mailpiece to be stacked so as to stack it on top of the head of the stack of envelopes in the storage receptacle while also exerting thrust on the head of the stack, thereby making space for accommodating the new mailpiece to be stacked.

The bucket wheel that turns in stop-start manner in half-turns and stops between each half-turn, can have a stacking rate that can be very high, and hitherto very sophisticated motors with electronic variable speed drives have been used for driving the bucket wheel of the stacker at variable speeds.

Such an electric motor with an electronic variable speed drive is very costly, limited in power, and complex to operate. In addition, it consumes energy continuously in order to power the electronics, and requires braking energy to be removed. It also poses problems of electronic reliability and of electromagnetic compatibility.

An object of the invention is to remedy those drawbacks.

### SUMMARY OF THE INVENTION

The basic idea of the invention is firstly to couple the mechanical transmission of the bucket wheel to a conventional clutch brake driven at constant speed, and secondly to couple the clutch brake to the bucket wheel via elliptical gearing made up of an elliptical pinion and of a gearwheel whose profile is complementary to the profile of the pinion (i.e. polygasteroid).

More generally, the invention provides a mechanical transmission assembly for transmitting rotary motion in stop-start manner to an actuator, said mechanical transmission assembly being characterized in that it comprises elliptical gearing coupled between the actuator and a clutch brake that has an inlet shaft driven in rotation at constant speed, in that the elliptical gearing comprises an elliptical pinion and a polygasteroid gearwheel whose profile is complementary to the profile of the pinion, and in that the clutch has an outlet axis that passes through a focus of the elliptical pinion, and the actuator has an inlet axis that passes through the centre of the gearwheel.

With this elliptical gearing arrangement, it is possible to have the rotary actuator turn through one half-turn without any jolting either on starting or on stopping, and while guaranteeing an accurate stopping position under conditions in which load varies. The freewheel effect between the clutching stage and the braking stage is removed because the elliptical gearing has a gear ratio that changes progressively.

At rest, the driven/driving gear ratio is minimized (very significantly less than 1). Starting therefore takes place at low speed and at high torque. Then the speed of the load increases progressively, going through a maximum (the gear ratio is then close to 1), and it then decreases symmetrically until the gearing stops.

On this basis, a stacker unit for stacking flat articles, e.g. a stacker unit that is adapted for sorting outlets of a postal sorting machine, with a stacking actuator of the bucket wheel type for stacking the mailpieces on edge in a storage receptacle may advantageously include a mechanical transmission assembly as indicated above for transmitting rotary motion in stop-start manner to the stacking actuator.

With this arrangement, it is therefore not necessary to have any servo-control electronics in order to perform the rotation cycle of the bucket wheel while the mailpieces are being stacked in the receptacle of the stacker.

With this arrangement, the electronic/software control of the actuator makes it possible:
to guarantee the desired stacking cycle (in terms of time and of stopping accuracy);
to maintain the bucket wheel in the rest position between two stacking operations;
to reset the position of the bucket wheel in the event the sorting machine in which the stacker unit is installed stops/restarts;
to facilitate manual clearance of jams by the operator of the stacking unit; and
to inhibit a sorting outlet of the sorting machine if necessary.

This arrangement also makes it possible to limit the number of sensors and their complexity, to simplify any adjustment of the stacking cycle, and to limit the electricity consumption of the stacker unit.

The mechanical transmission assembly of the invention may have the following features:
the outlet and inlet axes on the pinion and on the gearwheel of the elliptical gearing and a point of mutual contact between the pinion and the gearwheel are in alignment;
it may further comprise a position sensor for sensing the angular position of the gearwheel or of the pinion;
the position sensor may be an optical sensor;
the position sensor may be a magnetic sensor; and
the position sensor may be a capacitive sensor.

The invention can be understood more clearly on reading the following description of an embodiment that is shown in the drawings.

### BRIEF DESCRIPTION OF THE DRAWINGS

In the drawings:

FIG. 1 is a very diagrammatic view of a stacker unit with a rotary actuator of the bucket wheel type for a stacker unit for stacking mail in a sorting outlet of a postal sorting machine;

FIG. 2 shows the principle of the elliptical gearing of the invention;

FIG. 3 shows a first example of a configuration for the elliptical gearing with a clutch brake, e.g. for the stacker in FIG. 1;

FIG. 4 shows a second example of a configuration for the elliptical gearing with a clutch brake;

FIG. 5 shows the variation in the speed of rotation of the actuator as a function of the angular position of the pinion;

FIG. 6 shows elliptical gearing with a polygasteroidal gearwheel provided with detection zones for detecting the angular position of the actuator; and

FIG. 7 is a timing diagram for showing the electronic/software control of the actuator.

### DESCRIPTION OF EMBODIMENTS

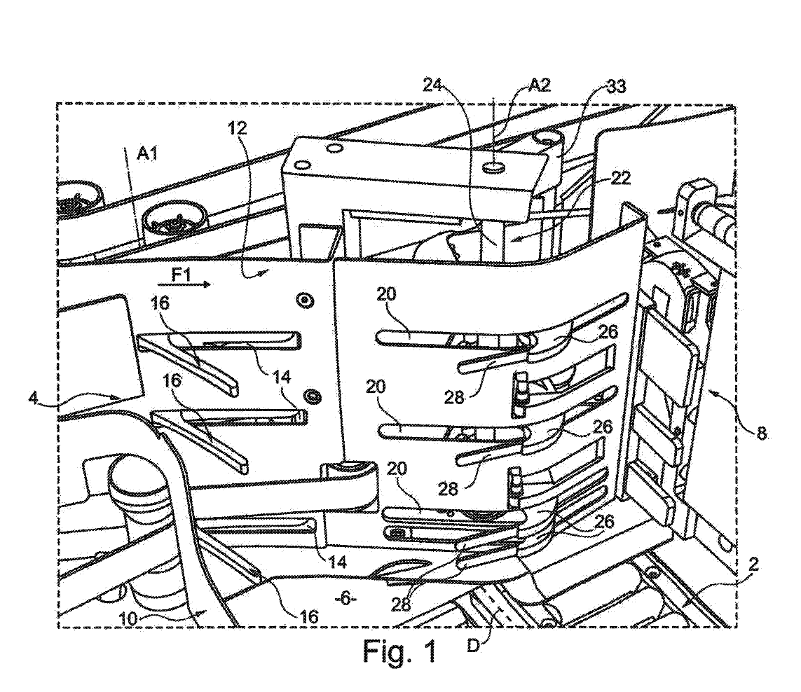

FIG. 1 shows, merely by way of example, a stacker device for stacking flat postal articles and having an electromechanical actuator of the bucket wheel type.

Firstly, the stacker device includes a stationary frame, designated by reference 2. It also has an inlet corridor 4, via which the flat postal articles arrive. In this example, the mailpieces are, more particularly, envelopes or letters of small and/or large format.

Typically, this inlet is put into communication with a conveyor device (not shown) that is part of a conventional-type postal sorting machine.

This stacker device also defines a zone 6 for receiving and storing the articles, which zone lies laterally between a jogging edge 8, against which the flat articles bear, and a retaining edge 10. In addition, the longitudinal direction of the device, in which direction the stack of flat articles moves as it is being formed, is referenced D.

A plate 12 forming a sliding edge makes it possible to guide the flow articles taken in from the inlet 4 towards the zone 6 as indicated by arrow F1.

In its upstream portion, with reference to the direction of advance of the articles, the plate 12 is provided with a first series of slots 14. Said slots enable a plurality of flaps 16 to pass through them, and, in the example shown, three such flaps are provided. These flaps are suitable for pivoting about a vertical axis A1 which extends in the vicinity of the back face of the plate 12.

As explained in more detail below, each flap can pivot about the axis A1 between two positions. The first of these positions is a retracted position, in which the flaps are retracted behind the plate 12, i.e. they do not project from the inlet corridor 4 and thus they do not interfere with the advance of the articles. In the second position or “extended” position, the flaps project into the corridor so as to influence the path of the articles, as explained below.

In its downstream portion, the plate 12 is provided with a second series of slots 20. These slots co-operate with an actuator 22 suitable for being driven in rotation about a vertical axis A2 that is spaced apart from the plate, away from the reception zone 6.

This electromechanical actuator 22 comprises a central hub 24, from which a plurality of pairs of spurs 26 extend, only one of which spurs in each pair is visible in this figure. Said spurs are suitable for projecting towards the reception zone, through the above-mentioned slots 20. In addition, said spurs are slightly curved in such a manner as to point towards the inlet corridor when they project through said slots.

More precisely, in the example shown, there are four pairs of such spurs 26, distributed along the hub 24. For any given pair, the two spurs extend symmetrically, thus being mutually offset by 180°.

Each spur 26 is associated with a tongue 28, which is advantageously mounted removably, e.g. by screw-fastening. The tongues may then be made of a material that is different from the material of which the spurs are made, and in particular of a plastics material, while the spurs are made of metal.

In this way, the tongues can have characteristics adapted to their function, while also being readily replaceable.

Each tongue 28 has a portion of curved shape, with a view to fastening it to the spur, and a rectilinear main portion that extends tangentially to a circle centered on the axis A2 and that is of radius lying in the range 60 millimeters (mm) to 80 mm. The spurs 26 with the tongues 28 form a sort of bucket wheel that acts like a bucket to take each flat article coming from the inlet corridor 4 so as to insert it onto the top of the stack of flat articles in the storage zone 6 of the stacker.

The longitudinal end of the reception zone, opposite from the actuator, is defined by a paddle (not shown in FIG. 1) forming a retaining element for retaining the flat articles on edge at the back of the storage zone.

This paddle is mounted to move relative to the frame 2, in the direction D, while being mounted on a guide. In addition, means (not shown) of the reel or counterweight type, are associated with the paddle so that it exerts a return force on the stack of articles, in such a manner as to retain the stack.

In accordance with the invention, the stacking actuator 22 is coupled in rotation, in this example to a motor-driven shaft, via to a clutch brake driven at constant speed by the motor-driven shaft, and elliptical gearing is provided between the clutch brake and said stacking actuator.

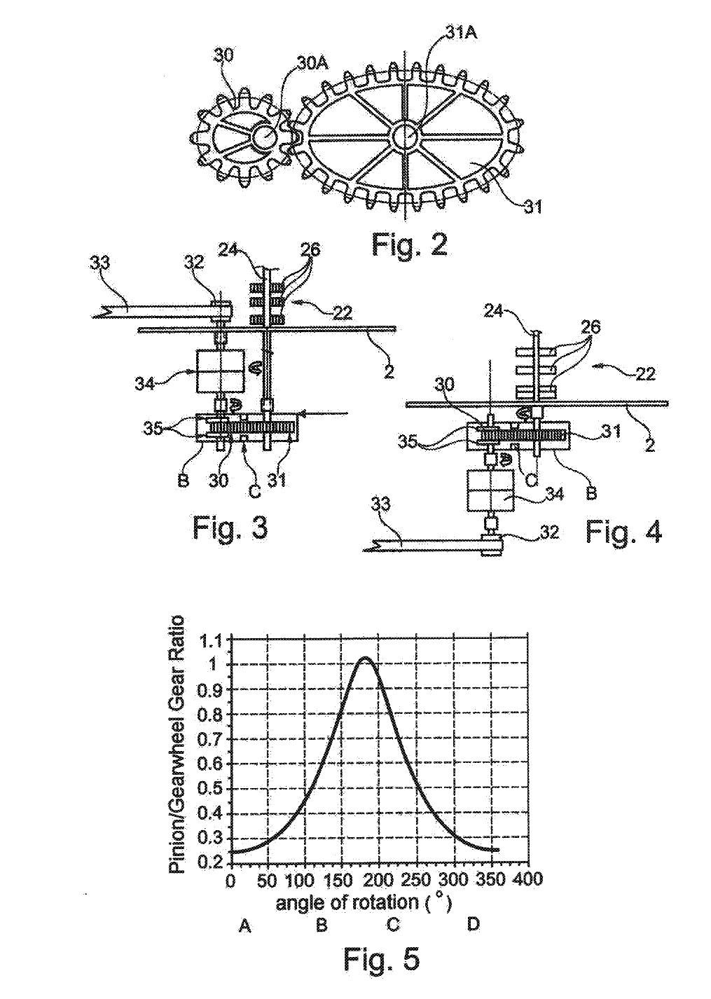

FIG. 2 is a very diagrammatic view of elliptical gearing of the invention, comprising an elliptical pinion 30 meshed with a polygasteroid gearwheel 31 having a profile that is complementary to the profile of the pinion 30.

As can be seen in FIG. 2, the pinion 30 has an axis of rotation 30A situated at one of the focuses of the elliptical pinion and the gearwheel 31 has an axis of rotation 31A that is central. The point of contact or of meshing between the pinion 30 and the gearwheel 31 and the axes 30A and 31A are in alignment.

The sets of teeth of the pinion and of the gearwheel are computed specifically as a function of the mathematical equations for the profiles of the pinion and of the gearwheel. The dimensions of the pinion and of the gearwheel are proportional and can be scaled to match requirements.

The minimum dimension is imposed by the strength of the teeth, as a function of the load corresponding to the actuator. The maximum dimension is limited only by inertia.

The pinion and the gearwheel may be made of a molded plastics material. When the load is high or when the available space is very small, the pinion and/or the gearwheel may be made of metal or else they may have two stages.

In accordance with the invention, the pinion and the gearwheel may be incorporated in a housing B shown in FIGS. 3 and 4, which housing has an inlet shaft and an outlet shaft.

The clutch brake is caused to stop after a fixed angle of rotation that depends only on the braking time of the clutch brake (and not on the load).

An elementary sensor C (an optical, magnetic, or capacitive sensor, depending on the situation) may be incorporated into the housing (see FIGS. 3 and 4) for detecting the angular position of the gearwheel 31. The sensor C is arranged to identify a particular point of the gearwheel 31 (a hole, a reflector, a metal zone, etc., depending on the type of sensor) or else a disk indexed on the gearwheel or on the pinion. This detection signal serves to trigger the braking command for applying the clutch brake 34. The position of the sensor C or of the corresponding point for identification can be adjusted in such a manner as to adapt the configuration to suit the dynamic characteristics of the clutch brake and guarantee good stopping accuracy.

The eccentricity “e” of the pinion 30 is chosen in such a manner as to offer a range of speeds that is sufficient without generating a peak speed that is too high. For example, the eccentricity is chosen to lie in the range 0.4 to 0.5 approximately. It can thus be understood that the higher the eccentricity of the elliptical pinion, the flatter it is (polar equation: r=p/[1+e cos(θ)], where p is a dimensional parameter) and it has a drive axis 30A that coincides with one of its two focuses.

The gearwheel 31 is of a shape (polar equation: r=4p/[k−1−e cos(2θ)], where k=1+√[4−3e2]) that is complementary to the pinion 30 and it has an axis of rotation 31A that coincides with its center.

The choice of the eccentricity (parameter “e”) for which the pinion determines the amplitude over which the gear ratio varies and also the progressiveness of the meshing, and the choice of the dimensional parameter “p” makes it possible to set the dimensions and the spacing between the axes of the pinion and of the gearwheel at will, without changing the eccentricity and thus without changing the progressiveness of the meshing.

FIG. 3 shows a motor-driven drive shaft 32, which, in this example, is a shaft driven by a motor-driven belt 33 mounted on the top of the frame 2 of the stacker, and which is coupled to the inlet of a clutch brake 34 that has its outlet coupled to the pinion 30 of the elliptical gearing.

The gearwheel 31 of the elliptical gearing is coupled at its outlet to the rotary actuator 22 via the transmission shaft 24.

In FIG. 4, the belt 33 driving the shaft 32 is mounted under the frame 2 of the stacker. The shaft is also coupled to the inlet of the clutch brake 34, which has its outlet coupled to the pinion 30. The gearwheel 31 is coupled at its outlet to the rotary actuator 22 via the transmission shaft 24.

One or more balance weights 35 may be provided on either side of the elliptical pinion 30 to remove any unbalance. The pinion 30 and the gearwheel 31 of the elliptical gearing may be made of a lightweight material, such as a plastics material, and the weights 35 then serve to increase the inertia of the pinion 30 in order to maintain the torque by the inertia effect while the clutch brake is freewheeling.

With reference to FIG. 5, during a stacking cycle, the gearwheel 31 turns through one half-turn while the pinion 30 turns through one full turn. In FIG. 5, the eccentricity “e” of the pinion is equal to 0.44.

More particularly, during the stage A in FIG. 5, the clutch brake 34 is clutched and the gearwheel 31 starts turning at a low speed from its rest position. During stage B in FIG. 5, the gearwheel 31 turns through one quarter-turn and reaches its maximum speed (the pinion 30 turns through one half-turn).

During stage C, the bucket wheel 26 pushes the envelope into the stack. After the position is detected by the sensor C, braking of the clutch brake is triggered so that the gearwheel 31 finishes its half-turn accurately.

During stage D, the bucket wheel 26 finishes pushing the envelope into the stack and stops at a low speed and in the rest position.

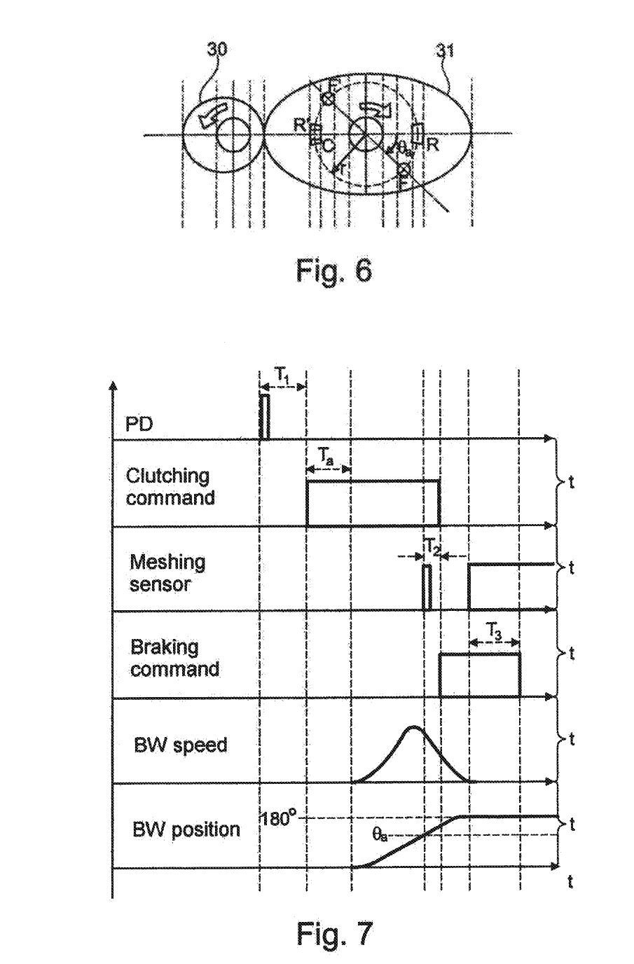

FIG. 6 shows the elliptical gearing of the invention with the polygasteroidal gearwheel 31 that is provided with detection zones for a detection sensor C, which, in this example, is a sensor with a photoelectric cell C that interacts with sensitive zones F, F′ made up of two diametrically opposite perforations in a disk that is mounted on the gearwheel 31 of the gearing in such manner that their axes coincide.

In this example, the two perforations F,F′ are at a certain distance r from the axis of the gearwheel 31 of the gearing and in advance of the braking reference position of the clutch brake by an angle θa in the direction of rotation, thereby detecting said braking reference position at each half-turn.

The braking of the clutch brake must be triggered once the bucket wheel 26 has travelled through an angle θf that is such that the bucket wheel finishes its stroke with the desired accuracy.

In view of the varying load that influences the braking, the angle θf is adjusted while unloaded, in such a manner that the end of stroke of the bucket wheel coincides with the maximum allowed stop position, e.g. 185°.

Therefore, it can be understood that an angular range R, R′ (e.g. 10° for stopping accuracy of ±5° is available so as to ensure that stopping is sufficiently accurate in the various possible load situations.

In practice, the angle θf can vary from one clutch brake to another due to production dispersion and ageing dispersion, thereby requiring an angle θa to be chosen that is greater than the maximum angle θf so as then to delay to some extent triggering of the braking of the clutch brake as from detection of the angle θa.

It should be noted that the asymmetry of the elliptical gearing allows angular position detection to take place either on the gearwheel or on the pinion of the elliptical gearing, but angular position detection on the gearwheel of the gearing, which gearwheel is normally of larger diameter than the pinion, procures increased accuracy.

The sensor C may also serve to detect the zero position of the bucket wheel 26 if the ranges R,R′ are detection zones for the sensor C.

This detection of the zones R, R′ makes it possible to interrupt the braking command once the rotation cycle is finished, thereby contributing to reducing the electricity consumption of said command, while also preventing a large variation in the position of the bucket wheel in the event the operator acts on the stack of mail in the stacker unit.

This detection also allows the angle θf of triggering of the braking to be automatically-adjusted because detection of point zero makes it possible to trigger an automatic sequence of unloaded cycles during which the time delay following detection of the angle is progressively increased until it reaches the beginning of the zero zone.

This detection of the zones R,R′ by the sensor C also makes it possible to trigger an unloaded cycle for resetting the bucket wheel before a new stacking stage, and to monitor and indicate over-frequent occurrences of situations in which the zero position is not reached during successive rotation cycles.

Typically, the clutch brake 34 can have an activation time Ta of about 16 milliseconds (ms), during which a mailpiece that enters the inlet corridor 4 of the stacker unit travels less than 70 mm at the maximum speed of 4 meters per second (m/s).

This distance is significantly less than the distance between the position of a passage detector detecting the mail going past in the stacker, e.g. associated with the flaps 16, and the position of the axis 33 of the bucket wheel 26.

In order to trigger a rotation cycle of the bucket wheel 26, it is necessary to anticipate the command with a time delay T1 that is adjustable between the passage detector detecting the leading edge of the mailpiece and actual powering of the clutch brake.

FIG. 7 is a timing diagram showing the various stages in the electronic/software control of the clutch brake as from mailpiece passage detection PD, i.e. detection of a mailpiece going past in the stacker unit.

After the time delay T1, the control coil of the clutch brake is activated for an activation time Ta.

After each activation of the clutch brake command, the bucket wheel 26 (BW in FIG. 7) reaching the angular position θa is detected in order to trigger a new time delay T2 at the end of which a braking command is applied.

When the zero position is detected in its turn, a new time delay T3 is triggered, at the end of which activation of the control coil of the clutch brake is interrupted. If the zero position is no longer detected, a braking command is applied.

This mode of operation of the control makes it possible to guarantee the desired cycle (in terms of time and of stopping accuracy), to maintain the bucket wheel in a rest position between two stacking operations, to reset the bucket wheel to the zero position in the event of stopping/re-starting, to facilitate manual clearance of jams by the operator, and to inhibit a sorting outlet of the sorting machine if necessary.

Detection of the angle θa takes place at the end of the cycle, and therefore at low speeds of rotation, and detection of the zero position is static detection.

In order to aim for accuracy of 0.5°, for example, at one quarter of the drive speed of the clutch brake (i.e., for example, 350 revolutions per minute (rpm)), it is necessary for the sensor to have accuracy to within about 0.5 ms (possible fluctuation in its response time of 0.5 ms).

Naturally, the configuration shown in FIGS. 3 and 4 is reversible. By having the gearwheel driven by the motor-driven shaft 32 and by placing the load 22 of the actuator on the pinion side, the configuration accelerates by a mean ratio of 2 (every time the gearwheel turns through one half-turn, the pinion turns through one full turn). To start and stop smoothly, the gearwheel of the gearing needs to be phase-shifted by 90° in the rest position (the pinion is then phase-shifted by) 180°.

The invention applies more particularly to a mail stacker for a sorting outlet of a postal sorting machine. The invention could also apply to other devices with electrically controlled movement for causing a rotary actuator to turn through one half-turn on command. In particular, the basic idea of the invention of using progressive gearing for guaranteeing good stopping accuracy during a fast cycle and under a varying load without using servo-control electronics may, for example, be applied to an electric motor, to an electromagnet, or to a jack-type actuator.

1. A mechanical transmission assembly for transmitting rotary motion in stop-start manner to an actuator, said mechanical transmission assembly comprising elliptical gearing coupled between said actuator and a clutch brake that has an inlet shaft driven in rotation at constant speed, wherein the elliptical gearing comprises an elliptical pinion and a polygasteroid gearwheel having a profile complementary to the profile of the pinion, and wherein the clutch has an outlet axis that passes through a focus of the elliptical pinion, and the actuator has an inlet axis that passes through a centre of the gearwheel.

2. A mechanical transmission assembly according to claim 1, wherein the outlet and inlet axes on the pinion and on the gearwheel of the elliptical gearing and a point of mutual contact between the pinion and the gearwheel are in alignment.

3. A mechanical transmission assembly according to any preceding claim 1, further comprising a position sensor for sensing an angular position of the gearwheel or of the pinion.

4. A mechanical transmission assembly according to claim 3, wherein said position sensor is an optical sensor.

5. A mechanical transmission assembly according to claim 3, wherein said position sensor is a magnetic sensor.

6. A mechanical transmission assembly according to claim 3, wherein said position sensor is a capacitive sensor.

7. A mechanical transmission assembly according to claim 1, wherein the pinion and the gearwheel are made of a plastics material.

8. A stacker unit comprising a stacking actuator for stacking flat articles on edge in a storage receptacle, and a mechanical transmission assembly according to claim 1 for transmitting rotary motion in stop-start manner to the stacking actuator.

9. A postal sorting machine, comprising sorting outlets, each of which has a stacker unit according to claim 8.
